(19) United States
(12) Patent Application Publication
(10) Pub. No.: US 2018/0164541 A1
(43) Pub. Date: Jun. 14, 2018

(54) DIGITAL MICROMIRROR DEVICE PROJECTOR

(71) Applicant: Delta Electronics, Inc., Taoyuan City (TW)

(72) Inventors: Meng-Sheng CHANG, Taoyuan City (TW); Hui-Hsiung WANG, Taoyuan City (TW)

(21) Appl. No.: 15/465,920

(22) Filed: Mar. 22, 2017

(30) Foreign Application Priority Data
Dec. 14, 2016 (CN) 201611152969.6

(51) Int. Cl. G02B 7/18; G02B 26/08; G03B 21/00; G03B 21/16

(52) U.S. Cl. CPC G02B 7/1815; G03B 21/16; G03B 21/008; G02B 26/0833

(57) ABSTRACT

A digital micromirror device projector is provided. The digital micromirror device projector includes a digital micromirror device chip, a heat conductive member, a thermo-electric cooler unit and a thermal insulator. The heat conductive member includes a heat conductive plate and a heat conductive protrusion. The heat conductive plate includes a first surface and a second surface, wherein the first surface is opposite to the second surface. The heat conductive protrusion is formed on the first surface. The heat conductive protrusion is thermally connected to the digital micromirror device chip by conduction. The thermo-electric cooler unit includes a cool side and a hot side, wherein the cool side is connected to the second surface. The thermal insulator is attached to the first surface. The thermal insulator surrounds the heat conductive protrusion.

### CROSS REFERENCE TO RELATED APPLICATIONS

This Application claims priority of China Patent Application No. 201611152969.6, filed on Dec. 14, 2016, the entirety of which is incorporated by reference herein.

### BACKGROUND OF THE INVENTION

### Field of the Invention

The present invention relates to a digital micromirror device projector, and in particular to a digital micromirror device projector utilizing a thermo-electric cooler unit.

Description of the Related Art

Thermo-electric coolers (TEC) are heat radiation components that utilize the Peltier effect in a semiconductor, whereby heat can be delivered from a spatial point A to another spatial point B; namely, the heat at point A will be transferred to point B so that the temperature at A will decrease and that at B will increase. Briefly stated, heat is absorbed at A and released at B. A typical thermo-electric cooler is composed of a train of pairs of P type and N type semiconductor crystal granules; each of the semiconductor pairs has a metallic (copper or aluminum) conductor disposed between the P type and N type semiconductors to form a circuit loop. The bulk of the respective semiconductor pairs are enclosed by two ceramic plates on both sides of the cooler. When the cooler is charged, the N-type semiconductors will release heat, and the P-type semiconductors will absorb heat. Therefore, a cooler made of a train of N/P pairs has a heat-absorbing side and a heat-releasing side, whereby the cooler will achieve heat dissipation by directional heat transport.

The illumination request of the digital micromirror device projector is gradually increased. Conventional heat dissipation designs cannot solve the problem of heat accumulation in the digital micromirror device projector. The thermo-electric cooler can be utilized in the digital micromirror device projector. However, the digital micromirror device projector includes a cool side and a hot side. When the temperature of the cool side is too low and the environmental humidity is too high, water droplets are condensed. If the water droplets fall on the digital micromirror device chip or other electronic elements, the digital micromirror device chip or the electronic elements can become damaged.

### BRIEF SUMMARY OF THE INVENTION

In one embodiment, a digital micromirror device projector is provided. The digital micromirror device projector includes a digital micromirror device chip, a heat conductive member, a thermo-electric cooler unit and a thermal insulator. The heat conductive member includes a heat conductive plate and a heat conductive protrusion. The heat conductive plate includes a first surface and a second surface, wherein the first surface is opposite to the second surface. The heat conductive protrusion is formed on the first surface. The heat conductive protrusion is thermally connected to the digital micromirror device chip by conduction. The thermo-electric cooler unit includes a cool side and a hot side, wherein the cool side is connected to the second surface. The thermal insulator is attached to the first surface. The thermal insulator surrounds the heat conductive protrusion.

In one embodiment, an outer profile of the thermal insulator on the first surface encloses a projection area of the thermos-electric cooler unit defined on the first surface.

In one embodiment, the thickness of the thermal insulator is greater than 0.8 mm, and the thermal conductivity of the thermal insulator is less than 2.5 w/mk.

In one embodiment, the thermal insulator is made of rubber.

In one embodiment, the thermo-electric cooler unit comprises a plurality of thermo-electric cooler chips, wherein the thermo-electric cooler chips are stacked up, each thermo-electric cooler chip comprises a cool surface and a hot surface, and the cool surfaces face the heat conductive member.

In one embodiment, the thermo-electric cooler unit corresponds to the heat conductive protrusion.

In one embodiment, the digital micromirror device projector further comprises a heat sink, and the heat sink is connected to the hot side of the thermo-electric cooler unit.

In one embodiment, the heat sink is a fin heat sink or a water-cooled heat sink.

In one embodiment, a thermal glue or a thermal pad is disposed between the heat conductive protrusion and the digital micromirror device chip.

In one embodiment, the digital micromirror device projector further comprises a circuit board and a holder, wherein the circuit board and the holder are located between the digital micromirror device chip and the first surface.

Applicant discovers that the water droplets are condensed on the first surface of the heat conductive plate when the thermo-electric cooler unit is utilized. Therefore, in the embodiments of the invention, the thermal insulator is attached to the first surface to prevent water droplets from condensing. The lifetime of the digital micromirror device projector is thereby increased, and the reliability of the digital micromirror device projector is improved.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a side view of a portion of the digital micromirror device projector of an embodiment of the invention;

FIG. 2 is a bottom view of a portion of the digital micromirror device projector of the embodiment of the invention;

FIG. 3 shows details of the structure of the thermo-electric cooler unit of the embodiment of the invention;

FIG. 4 shows a circuit board and a holder of the digital micromirror device projector of the embodiment of the invention; and

FIG. 5 shows a portion of the digital micromirror device projector of another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

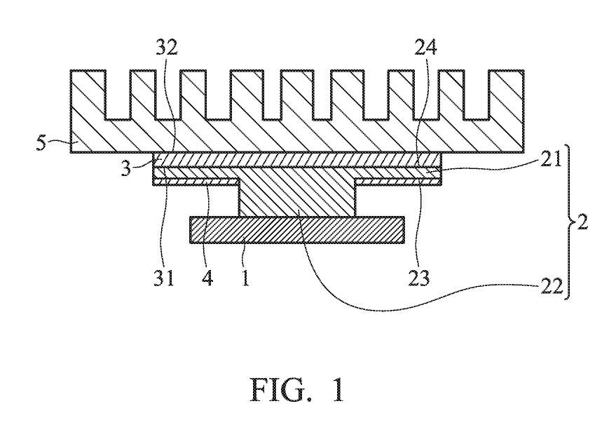

FIG. 1 is a side view of a portion of the digital micromirror device projector of the embodiment of the invention. The digital micromirror device projector includes a digital micromirror device chip 1, a heat conductive member 2, a thermo-electric cooler unit 3 and a thermal insulator 4. The heat conductive member 2 includes a heat conductive plate 21 and a heat conductive protrusion 22. The heat conductive plate 21 includes a first surface 23 and a second surface 24. The first surface 23 is opposite to the second surface 24. The heat conductive protrusion 22 is formed on the first surface 23. The heat conductive protrusion 22 is thermally connected to the digital micromirror device chip 1 by conduction. The thermo-electric cooler unit 3 includes a cool side 31 and a hot side 32. The cool side 31 is connected to the second surface 24. The thermal insulator 4 is attached to the first surface 23. The thermal insulator 4 surrounds the heat conductive protrusion 22.

In one embodiment, the heat conductive member 2 can be an integrally formed metal member, which can be made of copper, aluminum or another heat conductive material.

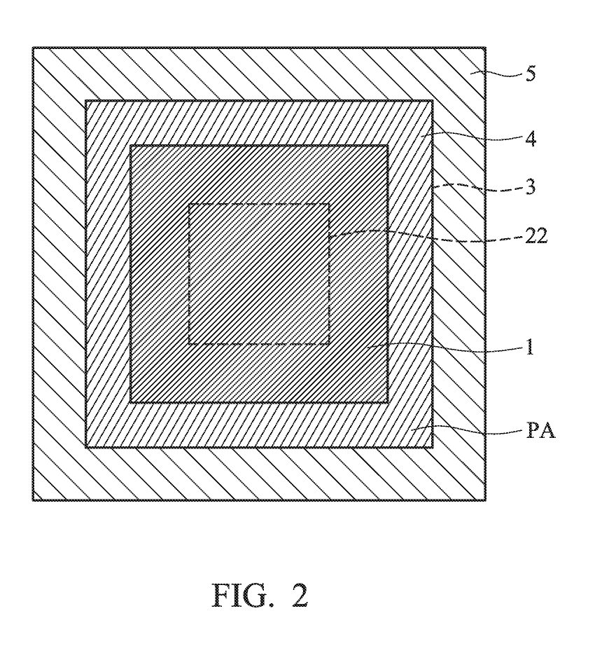

FIG. 2 is a bottom view of a portion of the digital micromirror device projector of the embodiment of the invention. With reference to FIGS. 1 and 2, in one embodiment, the thermo-electric cooler unit 3 forms a projection area PA on the first surface 23, and the area enclosed by the outer profile of the insulation area 4 is greater than or equal to the projection area PA. In this embodiment, the area of the thermo-electric cooler unit 3 is substantially equal to the area of the heat conductive plate 21. However, the disclosure is not meant to restrict the invention. In another embodiment, when the area of the thermo-electric cooler unit 3 is less than the area of the heat conductive plate 21. It is still preferable for the area enclosed by the outer profile of the insulation area 4 to be greater than or equal to the projection area PA.

In one embodiment, the thermal insulator is made of rubber. The thickness of the thermal insulator is greater than 0.8 mm, and the thermal conductivity of the thermal insulator is less than 2.5 w/mk. When relative humidity is 80% and the cooling power of the thermo-electric cooler unit is 30 W, water droplets are prevented from condensing. However, the disclosure is not meant to restrict the invention. The thermal insulator can be made of plastic or another thermal insulation material. The parameters disclosed above can be modified. Of particular relevance is the relationship between the thickness of the thermal insulator and the thermal conductivity of the thermal insulator. When the material and the dimensions of the thermal insulator are changed, the parameters disclosed above may be out of the value range disclosed above.

Applicant discovers that the water droplets are condensed on the first surface of the heat conductive plate when the thermo-electric cooler unit is utilized. Therefore, in the embodiments of the invention, the thermal insulator is attached to the first surface to prevent the condensation of water droplets. The lifetime of the digital micromirror device projector is increased, and the reliability of the digital micromirror device projector is improved.

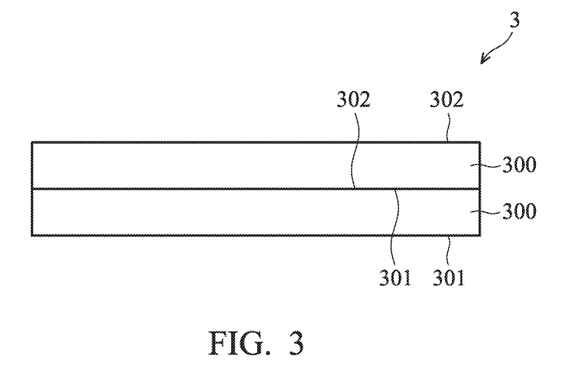

With reference to FIG. 3, in another embodiment, the thermo-electric cooler unit 3 comprises a plurality of thermo-electric cooler chips 300. The thermo-electric cooler chips 300 are stacked up. Each of the thermo-electric cooler chips 300 comprises a cool surface 301 and a hot surface 302. The cool surfaces face 301 to the heat conductive member 2. In this embodiment, there are two the thermo-electric cooler chips 300. However, the disclosure is not meant to restrict the invention, and the number of thermo-electric cooler chips 300 can be more than two.

With reference to FIGS. 1 and 2, in one embodiment, the thermo-electric cooler unit 3 corresponds to the heat conductive protrusion 22. In this embodiment, the heat conductive protrusion 22 substantially corresponds to the center of the thermo-electric cooler unit 3 to achieve uniform and sufficient heat transmission.

With reference to FIGS. 1 and 2, in one embodiment, the digital micromirror device projector further comprises a heat sink 5, and the heat sink 5 is connected to the hot side 32 of the thermo-electric cooler unit 3. In FIG. 1, the heat sink 5 is a fin heat sink. However, the disclosure is not meant to restrict the invention, the heat sink 5 can also be a water-cooled heat sink or another type of heat sink.

With reference to FIGS. 1 and 2, in one embodiment, a thermal glue or a thermal pad is disposed between the heat conductive protrusion 22 and the digital micromirror device chip 1 to improve heat conduction. Similarly, the thermal glue or the thermal pad can be disposed between the heat sink 5 and the thermo-electric cooler unit 3 to improve heat conduction. The thermal glue or the thermal pad can be disposed between the heat conductive plate 21 and the thermo-electric cooler unit 3 to improve heat conduction.

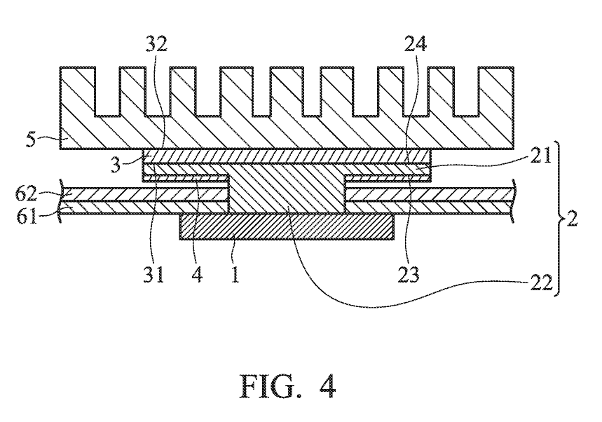

With reference to FIG. 4, in one embodiment, the digital micromirror device projector further comprises a circuit board 61 and a holder 62. The circuit board 61 and the holder 62 are located between the digital micromirror device chip 1 and the first surface 23. The digital micromirror device chip 1 is disposed on a surface of the circuit board 61. The heat conductive member 2 passes the circuit board 61 from the other surface of the circuit board 61 to contact the digital micromirror device chip 1. The holder 62 fastens the heat conductive member 2, the thermo-electric cooler unit 3, the thermal insulator 4 and the heat sink 5 to the circuit board 61. In one embodiment, the heat sink 5 is fastened to the holder 62 by screws, and the position of the heat conductive member 2, the thermo-electric cooler unit 3 and the thermal insulator 4 are fastened thereby. The holder 62 is fastened to the circuit board 61 by screws.

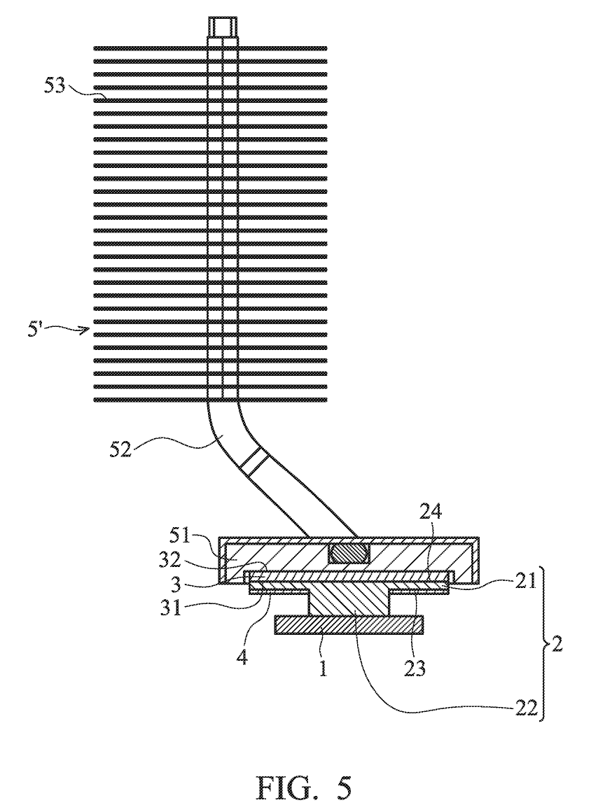

FIG. 5 shows a portion of the digital micromirror device projector of another embodiment of the invention. Similar to the previous embodiment, the digital micromirror device projector includes a digital micromirror device chip 1, a heat conductive member 2, a thermo-electric cooler unit 3 and a thermal insulator 4. The heat conductive member 2 includes a heat conductive plate 21 and a heat conductive protrusion 22. The heat conductive plate 21 includes a first surface 23 and a second surface 24. The first surface 23 is opposite to the second surface 24. The heat conductive protrusion 22 is formed on the first surface 23. The heat conductive protrusion 22 is thermally connected to the digital micromirror device chip 1 by conduction. The thermo-electric cooler unit 3 includes a cool side 31 and a hot side 32. The cool side 31 is connected to the second surface 24. The thermal insulator 4 is attached to the first surface 23. The thermal insulator 4 surrounds the heat conductive protrusion 22. In this embodiment, a heat sink 5′ is connected to the hot side 32 of the thermo-electric cooler unit 3. The heat sink 5′ includes a heat conductive structure 51, a heat pipe 52 and a fin module 53. The heat conductive structure 51 is connected to the hot side 32 of the thermo-electric cooler unit 3. The heat pipe 52 is connected to the heat conductive structure 51 and the fin module 53. In one embodiment, the fin module 53 corresponds to a fan. Utilizing the embodiment of FIG. 5, the heat pipe 52 is connected to the heat conductive structure 51 and the fin module 53, and the arrangement of the location of the fin module 53 is flexible.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A digital micromirror device projector, comprising:
a digital micromirror device chip;
a heat conductive member, comprising:
a heat conductive plate, comprising a first surface and a second surface, wherein the first surface is opposite to the second surface; and
a heat conductive protrusion, formed on the first surface, wherein the heat conductive protrusion is thermally connected to the digital micromirror device chip by conduction;
a thermo-electric cooler unit, comprising a cool side and a hot side, wherein the cool side is connected to the second surface; and
a thermal insulator, attached to the first surface, wherein the thermal insulator surrounds the heat conductive protrusion.

2. The digital micromirror device projector as claimed in claim 1, wherein an outer profile of the thermal insulator on the first surface encloses a projection area of the thermos-electric cooler unit defined on the first surface.

3. The digital micromirror device projector as claimed in claim 1, wherein a thickness of the thermal insulator is greater than 0.8 mm, and a thermal conductivity of the thermal insulator is less than 2.5 w/mk.

4. The digital micromirror device projector as claimed in claim 1, wherein the thermal insulator is made of rubber.

5. The digital micromirror device projector as claimed in claim 1, wherein the thermo-electric cooler unit comprises a plurality of thermo-electric cooler chips, the thermo-electric cooler chips are stacked up, each thermo-electric cooler chip comprises a cool surface and a hot surface, and the cool surfaces face to the heat conductive member.

6. The digital micromirror device projector as claimed in claim 1, wherein the thermo-electric cooler unit and the heat conductive protrusion are correspondingly arranged.

7. The digital micromirror device projector as claimed in claim 1, further comprising a heat sink, which is connected to the hot side of the thermo-electric cooler unit.

8. The digital micromirror device projector as claimed in claim 7, wherein the heat sink is a fin heat sink or a water-cooled heat sink.

9. The digital micromirror device projector as claimed in claim 1, wherein a thermal glue or a thermal pad is disposed between the heat conductive protrusion and the digital micromirror device chip.

10. The digital micromirror device projector as claimed in claim 1, further comprising a circuit board and a holder, and the circuit board and the holder are located between the digital micromirror device chip and the first surface.
